(19) United States
(12) Patent Application Publication
(10) Pub. No.: US 2021/0090088 A1
(43) Pub. Date: Mar. 25, 2021

(54) MACHINE-LEARNING-BASED DIGITAL PLATFORM WITH BUILT-IN FINANCIAL EXPLOITATION PROTECTION

(71) Applicant: Bank of America Corporation, Charlotte, NC (US)

(72) Inventors: Elena Kvochko, New York, NY (US); Katherine Dintenfass, Lincoln, RI (US)

(21) Appl. No.: 16/578,477

(22) Filed: Sep. 23, 2019

(51) Int. Cl. G06Q 20/42; G06N 20/20; G06Q 50/00; G06Q 20/40

(52) U.S. Cl. CPC G06Q 20/42; G06Q 20/4016; G06Q 50/01; G06N 20/20

(57) ABSTRACT

Systems and methods for machine-learning (ML)-based platforms with built-in financial exploitation protection are provided. A method may include receiving, at a processor, a plurality of opt-ins from a plurality of contributors. The method may include retrieving and storing historical and contextual data. Historical data may include information on the activities of the contributors. The method may include training an ML module. The training may be based at least in part on the historical data. The method may include processing, via the processor and/or in conjunction with the ML module, a dataset. The processing may identify a potential exploitation. The identifying implements sentiment analysis in identifying the potential exploitation. The method may include generating a recovery package. The recovery package is one or more financial services that may be provided via the processor. The recovery package may mitigate the potential exploitation.

### FIELD OF TECHNOLOGY

Aspects of the disclosure relate to digital systems. Specifically, aspects of the disclosure relate to digital transactional systems with built-in safety mechanisms.

### BACKGROUND OF THE DISCLOSURE

Digital transactional systems leverage digital technology to provide a powerful and convenient mechanism for executing transactions. Transactions may, for example, include purchases, transfers, exchanges, loans, payments, and other suitable financial transactions. A digital transactional system may be able to execute the transactions substantially instantaneously, across vast distances, and at a large scale.

Conventional digital transactional systems, however, may be associated with a number of potential vulnerabilities. One potential vulnerability may include the risk of an account or a transactional instrument being exploited by a third party. The third party may be someone close to the primary account holder. The third party may even be an authorized user on the account. The third party may, for example, be an abusive relative or spouse who is in a position to access the account or transactional instrument with relative ease, and who may use the access to coercively execute unauthorized transactions.

It would be desirable, therefore, to provide systems and methods for digital transactional architectures. It would be further desirable for the architectures to include built-in safety mechanisms, including those that reduce the risk of financial exploitation.

It would be yet further desirable to use sentiment analysis to leverage private and public sources of information to identify potential exploitation.

### SUMMARY OF THE DISCLOSURE

Aspects of the disclosure relate to apparatus and methods for a machine-learning (ML)-based digital system for mitigating financial exploitation. The system may include a central server. The central server may include a processor and a memory.

The system may include a financial services module. The financial services module may be configured to provide a set of financial services. The financial services module may provide the set of financial services via the central server.

The system may include a database. The database may be stored in the memory. The database may include historical data. The historical data may include information on the activities of a plurality of contributors. The processor may be configured to retrieve the information in response to the contributors opting-in to contribute to the historical data. Such ML models may implement sentiment analysis. Sentiment analysis, as used herein, is explained in more detail below.

The system may include an ML module. The ML module may include a set of ML models. The set of ML models may be trained based on the historical data in the database. The ML models may use more current and contextual data from public or identified private sources.

The system may include an identifier module. The identifier module may be configured to process a dataset. The identifier may also be configured to identify a potential exploitation. The identifying may be executed in conjunction with the ML module. The identifying may be implemented in conjunction with performing a sentiment analysis.

The system may include a recovery module. The recovery module may be configured to generate a recovery package. The generating may be executed in conjunction with the ML module. The recovery package may include one or more financial services from the set of financial services provided by the financial services module. The recovery package may be configured to mitigate the potential exploitation.

### BRIEF DESCRIPTION OF THE DRAWINGS

The objects and advantages of the disclosure will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows an illustrative apparatus in accordance with principles of the disclosure;

FIG. 3 shows an illustrative system architecture in accordance with principles of the disclosure;

FIG. 4 shows another illustrative system architecture in accordance with principles of the disclosure; and

FIG. 5 shows an illustrative flowchart in accordance with principles of the disclosure.

### DETAILED DESCRIPTION OF THE DISCLOSURE

Apparatus and methods for a machine-learning (ML)-based digital system for mitigating financial exploitation are provided. Financial exploitation may include scenarios where a third-party gains access to a financial service of an individual or entity and may use it contrary to the desires of the individual or entity.

The system may include a central server. The central server may be physically located in one location. The central server may be logically central. The central server may be distributed. The central server may be, at least in part, cloud-based.

The central server may include a processor and a memory. The memory may be non-transitory. The system may include computer code (i.e., computer executable instructions). The code may be stored in the memory. The code may be configured to run on the processor. Running the code on the processor may implement some or all of the system elements and method steps.

The system may include a financial services module. The financial services module may be configured to provide a set of financial services. The set of financial services may include accounts (e.g., checking, savings, investment, etc.), transactional instruments (e.g., credit cards, debit cards), loans, and other suitable financial services. The financial services module may provide the set of financial services directly (i.e., independently) or indirectly (i.e., via a third-party provider). The financial services module may provide the set of financial services via the central server.

The system may include a database. The database may be stored in the memory. The database may include historical data. The historical data may include information on the activities of a plurality of contributors. The processor may be configured to retrieve the information in response to the contributors opting-in to contribute to the historical data.

The system may include an ML module. The ML module may include a set of ML models. The set of ML models may be trained, at least in part, based on the historical data in the database. In some embodiments, the ML models may be trained at least in part based on artificial data compiled for the training.

The system may include an identifier module. The identifier module may be configured to process a dataset. The dataset may also include information on the activities of an individual. In certain embodiments, the dataset may include data social media activity, environment data, financial activity, news reports, and/or other available information relating to the individual, or to the public at large. Furthermore, in certain embodiments, the individual may have opted-in to share the dataset.

The identifier module may be configured to identify, preferably using sentiment analysis, a potential exploitation based on the dataset. The identifying may be executed in conjunction with the ML module. For example, the ML module may include a component trained or otherwise configured to generate an output, such as a score. The output may be indicative of a probability of a potential exploitation occurring or likely to occur based on the activity represented in the input dataset. In some embodiments, the identifier module may be configured to identify potential exploitations by comparing the dataset to known activity profiles of exploitations.

The system may include a recovery module. The recovery module may be configured to generate a recovery package. In some embodiments, the recovery module may generate a default recovery package for some or all potential exploitations. In other embodiments, the recovery module may generate targeted recovery packages tailored to the specific potential exploitation identified in the dataset. The generating may be executed in conjunction with the ML module. In some embodiments, multiple recovery package options may be generated for the dataset. The package may be further customized for the individual using sentiment analysis review of the potential exploitation.

The recovery package may include one or more financial services from the set of financial services provided by the financial services module. The recovery package may be configured to mitigate the potential exploitation. In some embodiments, the system may be configured to implement the recovery package automatically. In other embodiments, the recovery package may be offered to the subject of the dataset, and implementation may depend on the subject selecting or otherwise accepting the recovery package.

In some embodiments of the system, the set of ML models may include an exploitation model. The exploitation model may be configured to classify, preferably using sentiment analysis, a pattern of activity and determine an association with (e.g., a score representing a probability of) an exploitation.

In certain embodiments, the set of ML models may include a recovery model. The recovery model may be configured to classify, preferably using sentiment analysis, a pattern of activity and determine an association with (e.g., a score representing a probability of) a recovery from an exploitation.

The system may also include a set of exploitation profiles. The set of exploitation profiles may be stored in the database. Each of the exploitation profiles may include a pattern of activity that is associated, by the exploitation model, with an exploitation.

The system may further include a set of recovery profiles. The set of recovery profiles may be stored in the database. Each of the recovery profiles may include a pattern of activity that is associated, by the recovery model, with a recovery from an exploitation. In some embodiments, the system may also track patterns of activity that were not successful in recovering from an exploitation.

The system may, in some embodiments, include a mapping. The mapping may link each of the recovery profiles to one or more exploitation profiles. A link may represent a successful recovery, via the linked recovery profile, from the exploitation associated with the linked exploitation profile.

In certain embodiments, the recovery module may generate the recovery package based, at least in part, on the set of exploitation profiles, the set of recovery profiles, and/or the mapping. For example, the system may identify a potential exploitation based on processing the dataset. The system may compare the identified potential exploitation to the set of exploitation profiles, and determine the exploitation profile that is most similar to the potential exploitation. The recovery module may generate the recovery package at least in part based on the recovery profile that is mapped to the exploitation profile determined to be most similar.

In certain embodiments, the historical data may include social media activity. The historical data may also include financial activity. The exploitation profiles may be based on the social media activity, and the recovery profiles may be based on the financial activity.

The system may, in some embodiments, further include a connection module. The connection module may be configured to create a digital communication link between an individual associated with the potential exploitation and one or more individuals associated with recovery profiles. The digital communication link may facilitate communication between an individual currently experiencing an exploitation and an individual who successfully overcame an exploitation. The communication may serve to further mitigate the current exploitation and/or provide any other suitable assistance. In some embodiments, the communication link may be configured to retain the anonymity of some or all of the parties involved.

The system may also include a filtering module. The filtering module may be configured to retrieve contextual data. The filtering module may also be configured to leverage the contextual data to improve accuracy of the exploitation model. Improving the accuracy may be associated with reducing false positives in determining the exploitation profiles. For example, an individual may be employed in a line of work that includes research about security. This individual may be associated with a social media presence that includes a lot of discussion about exploitations. A system may falsely determine that this individual is likely the victim of exploitation. However, a filtering module may retrieve contextual data that, in this example, may include the employment of the individual in the field of security. Leveraging the contextual data may allow the system to filter out research-based mentions of exploitation from the dataset. This filtering may increase the accuracy of the system.

A machine-learning (ML)-based method for mitigating financial exploitation is provided. The method may include receiving, at a processor, a plurality of opt-ins. Each opt-in may be transmitted from one of a plurality of contributors.

The method may include retrieving historical data. Historical data may include information on the activities of the contributors. The method may also include storing the historical data as a database in a memory.

The method may, in some embodiments, include retrieving, via the processor, data about social media activity and/or financial activity of an individual. The individual may have opted-in to share the data. The method may also include compiling said data into the dataset.

The method may include training a machine-learning (ML) module. The training may be based at least in part on the historical data. The ML module may include a set of ML models. The training may be based at least in part on the contextual data.

The method may include processing a dataset. The processing may be implemented at least in part via the processor and/or in conjunction with the ML module. The processing may identify a potential exploitation.

The method may include generating a recovery package. The generating may be performed at least in part in conjunction with the ML module. The recovery package may include one or more financial services from a set of financial services. The set of financial services may be provided via the processor. The recovery package may be configured to mitigate the potential exploitation.

In some embodiments, the set of ML models may include an exploitation model and/or a recovery model. The exploitation model may be configured to classify, preferably using sentiment analysis, a pattern of activity and determine an association with an exploitation. The recovery model may be configured to classify a pattern of activity and determine an association with a recovery from an exploitation.

The method may also include compiling a set of exploitation profiles and/or recovery profiles. Each of the exploitation profiles may include a pattern of activity that is associated, by the exploitation model, with an exploitation. Each of the recovery profiles may include a pattern of activity that is associated, by the recovery model, with a recovery from an exploitation.

The method may further include creating a mapping. The mapping may link each of the recovery profiles to one or more exploitation profiles. A link may represent a successful recovery, via the linked recovery profile, from the exploitation associated with the linked exploitation profile.

Generating the recovery package may be based at least in part on the set of exploitation profiles, the set of recovery profiles, and/or the mapping.

In some embodiments, the method may further include creating a digital communication link between an individual associated with the potential exploitation and one or more individuals associated with recovery profiles.

In certain embodiments of the method, the historical data may include social media activity, financial activity, environment data, news reports and/or any other available information. The method may further include basing the exploitation profiles on the social media activity, and basing the recovery profiles on the financial activity.

The method may also include retrieving contextual data, and leveraging the contextual data to improve accuracy of the exploitation model and to reduce false positives in determining the exploitation profiles.

In certain embodiments, the method may further include implementing the recovery package automatically.

A digital financial platform with built-in exploitation protection is provided. The platform may be configured to provide a set of financial services. The financial services may be provided via a processor.

The platform may also include an identifier module. The identifier module may be configured to process a dataset, and identify a potential exploitation. The processing and/or identifying may be performed in conjunction with the ML module.

The platform may also include a recovery module. The recovery module may be configured to generate a recovery package. The generating may be performed in conjunction with the ML module. The recovery package may include one or more financial services from the set of financial services provided by the platform. The recovery package may be configured to mitigate the potential exploitation.

The platform may, in some embodiments, further include an exploitation model and/or a recovery model. The exploitation model and/or the recovery model may be part of the set of ML models. The exploitation model may be configured to classify a pattern of activity and determine an association with an exploitation. The recovery model may be configured to classify a pattern of activity and determine an association with a recovery from an exploitation.

The platform may, in certain embodiments, include a connection module. The connection module may be configured to create a digital communication link between an individual associated with the potential exploitation and one or more individuals associated with recovery profiles.

The platform may, in some embodiments, include a filtering module. The filtering module may be configured to retrieve contextual data. The filtering module may also be configured to leverage the contextual data to improve accuracy of the exploitation model, and to reduce false positives in determining the exploitation profiles.

In certain embodiments of the platform, the historical data may include social media activity and/or financial activity. In some embodiments, the exploitation profiles may be based at least in part on the social media activity, and/or the recovery profiles may be based at least in part on the financial activity. Furthermore, the dataset may include data about social media activity and/or financial activity of an individual who opted-in to share such data.

Some embodiments of the invention may extend beyond exploitation and recovery. For example, certain embodiments may involve sentiment analysis implementation. Sentiment analysis, as explained below, may be used to identify exploitation and/or to form approaches to recovery.

Sentiment analysis is the process of computationally identifying and categorizing opinions expressed in a piece of text. In one case, sentiment analysis implementation may determine whether the written/stated attitude towards a particular topic, product, etc., is positive, negative or neutral.

In one implementation, the system may perform a sentiment analysis on the transactions of a credit card by combining the information in the transactions with public data to infer a sentiment. Such public data may reflect environmental information, social media, local area news, weather, or any other suitable public information. The transactions of the credit card, or any other suitable private data, may be combined with the public data described above. The analysis of the combination of private data and public data may reveal sentiment that may be otherwise hard to detect.

For instance, some entities may use transactional data to profile customers and predict what they will buy next and what other services they might currently like. To expand on this, some entities may analyze why a recent purchase was made and leverage the analysis to promote future contact with the purchaser.

In one exemplary situation, a train ticket may have been purchased from a transportation ticketing entity by a customer located in the state of Florida. In the same, or similar, timeframe, weather reports may have placed residents on high alert of an upcoming hurricane in the same, or a similar location. As stated above, the location is Florida. Social media is trending with news and revealing that the public is highly concerned regarding the current situation. In such a scenario, the sentiment analysis is positive, as the person is likely taking pro-active steps to flee forecasted hazardous weather. Accordingly, public and private information has been leveraged to make a determination regarding customer sentiment.

Such a determination may trigger various responses. These various responses may be considered as recovery responses in connection with the recovery responses set forth in this application.

The various responses may include informing the customer of emergency services associated with the entity or with other relevant institutions; providing possible emergency products for customer purchase or any other suitable recovery response information that may be useful to the customer.

In another exemplary situation, a train ticket was purchased. The substantially contemporaneous, publicly-reported, weather is perfect. However, social media analysis shows personal posts associated with the customer to be negative and sad. In addition, other private information reveals that one or more large medical bills was paid recently. Also, other overdue expenses and/or an unpaid credit card balance exist. Furthermore, an unusual purchase pattern was likewise identified. Accordingly, in such a situation, the sentiment analysis is negative, as the person may be in a distress—similar to the exploitation scenarios set forth herein. Systems according to the embodiments may flag the customer's account. Moreover, alerting mechanisms to relatives/friends/doctor etc., may be enabled, and, depending on the severity of the sentiment analysis, activated.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is understood that other embodiments may be utilized, and that structural, functional, and procedural modifications may be made without departing from the scope and spirit of the present disclosure.

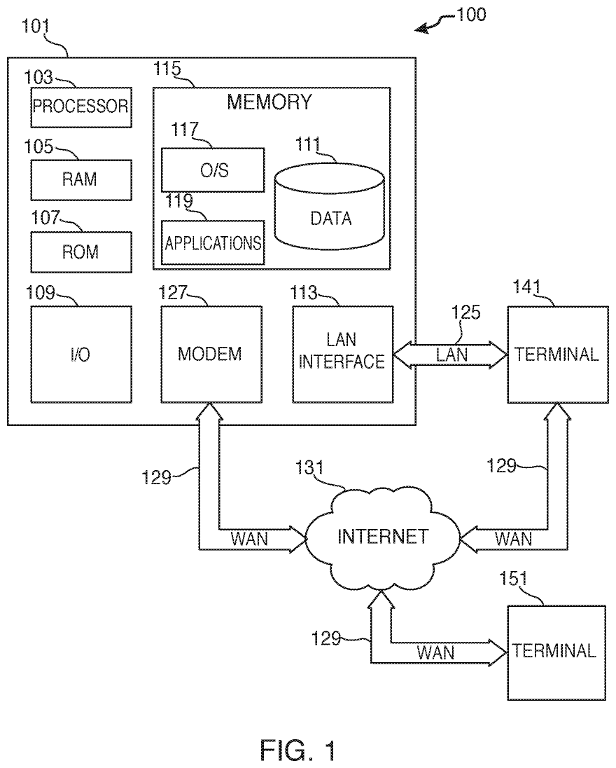

FIG. 1 shows an illustrative block diagram of system 100 that includes computer 101. Computer 101 may alternatively be referred to herein as a “server” or a “computing device.” Computer 101 may be a desktop, laptop, tablet, smart phone, or any other suitable computing device. Elements of system 100, including computer 101, may be used to implement various aspects of the systems and methods disclosed herein.

Computer 101 may have a processor 103 for controlling the operation of the device and its associated components, and may include RAM 105, ROM 107, input/output module 109, and a memory 115. The processor 103 may also execute all software running on the computer—e.g., the operating system and/or voice recognition software. Other components commonly used for computers, such as EEPROM or Flash memory or any other suitable components, may also be part of the computer 101.

The memory 115 may be comprised of any suitable permanent storage technology—e.g., a hard drive. The memory 115 may store software including the operating system 117 and application(s) 119 along with any data 111 needed for the operation of the system 100. Memory 115 may also store videos, text, and/or audio assistance files. The videos, text, and/or audio assistance files may also be stored in cache memory, or any other suitable memory. Alternatively, some or all of computer executable instructions (alternatively referred to as “code”) may be embodied in hardware or firmware (not shown). The computer 101 may execute the instructions embodied by the software to perform various functions.

Input/output (“I/O”) module may include connectivity to a microphone, keyboard, touch screen, mouse, and/or stylus through which a user of computer 101 may provide input. The input may include input relating to cursor movement. The input may relate to digital transactions and/or digital financial systems. The input may be related to machine-learning-based systems, and/or the training thereof. The input/output module may also include one or more speakers for providing audio output and a video display device for providing textual, audio, audiovisual, and/or graphical output. The input and output may be related to computer application functionality.

System 100 may be connected to other systems via a local area network (LAN) interface 113.

System 100 may operate in a networked environment supporting connections to one or more remote computers, such as terminals 141 and 151. Terminals 141 and 151 may be personal computers or servers that include many or all of the elements described above relative to system 100. The network connections depicted in FIG. 1 include a local area network (LAN) 125 and a wide area network (WAN) 129, but may also include other networks. When used in a LAN networking environment, computer 101 is connected to LAN 125 through a LAN interface or adapter 113. When used in a WAN networking environment, computer 101 may include a modem 127 or other means for establishing communications over WAN 129, such as Internet 131.

It will be appreciated that the network connections shown are illustrative and other means of establishing a communications link between computers may be used. The existence of various well-known protocols such as TCP/IP, Ethernet, FTP, HTTP and the like is presumed, and the system can be operated in a client-server configuration to permit a user to retrieve web pages from a web-based server. The web-based server may transmit data to any other suitable computer system. The web-based server may also send computer-readable instructions, together with the data, to any suitable computer system. The computer-readable instructions may be to store the data in cache memory, the hard drive, secondary memory, or any other suitable memory.

Additionally, application program(s) 119, which may be used by computer 101, may include computer executable instructions for invoking user functionality related to communication, such as e-mail, Short Message Service (SMS), and voice input and speech recognition applications. Application program(s) 119 (which may be alternatively referred to herein as “plugins,” “applications,” or “apps”) may include computer executable instructions for invoking user functionality related performing various tasks. The various tasks may be related to digital transactions and/or digital financial systems. The various tasks may be related to machine-learning-based systems, and/or the training thereof.

Computer 101 and/or terminals 141 and 151 may also be devices including various other components, such as a battery, speaker, and/or antennas (not shown).

Terminal 151 and/or terminal 141 may be portable devices such as a laptop, cell phone, Blackberry™, tablet, smartphone, or any other suitable device for receiving, storing, transmitting and/or displaying relevant information. Terminals 151 and/or terminal 141 may be other devices. These devices may be identical to system 100 or different. The differences may be related to hardware components and/or software components.

Any information described above in connection with database 111, and any other suitable information, may be stored in memory 115. One or more of applications 119 may include one or more algorithms that may be used to implement features of the disclosure, and/or any other suitable tasks.

The invention may be operational with numerous other general purpose or special purpose computing system environments or configurations. Examples of well-known computing systems, environments, and/or configurations that may be suitable for use with the invention include, but are not limited to, personal computers, server computers, hand-held or laptop devices, tablets, mobile phones, smart phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

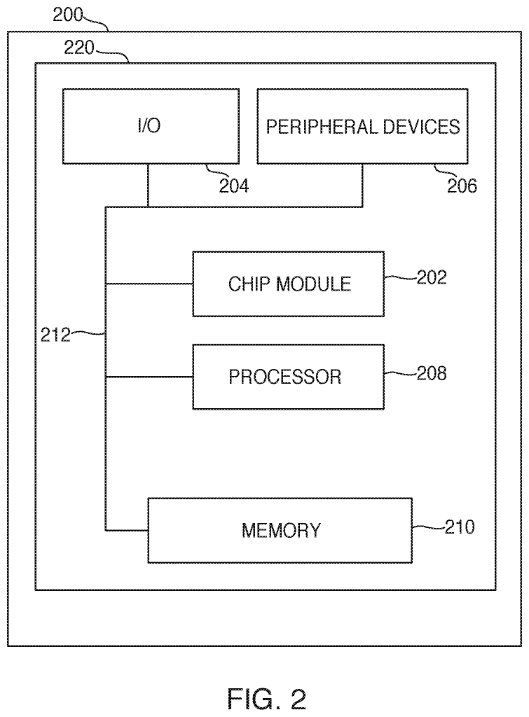

FIG. 2 shows illustrative apparatus 200 that may be configured in accordance with the principles of the disclosure. Apparatus 200 may be a computing machine. Apparatus 200 may include one or more features of the apparatus shown in FIG. 1. Apparatus 200 may include chip module 202, which may include one or more integrated circuits, and which may include logic configured to perform any other suitable logical operations.

Apparatus 200 may include one or more of the following components: I/O circuitry 204, which may include a transmitter device and a receiver device and may interface with fiber optic cable, coaxial cable, telephone lines, wireless devices, PHY layer hardware, a keypad/display control device or any other suitable media or devices; peripheral devices 206, which may include counter timers, real-time timers, power-on reset generators or any other suitable peripheral devices; logical processing device 208, which may compute data structural information and structural parameters of the data; and machine-readable memory 210.

Machine-readable memory 210 may be configured to store in machine-readable data structures: machine executable instructions (which may be alternatively referred to herein as “computer instructions” or “computer code”), applications, signals, and/or any other suitable information or data structures.

Components 202, 204, 206, 208 and 210 may be coupled together by a system bus or other interconnections 212 and may be present on one or more circuit boards such as 220. In some embodiments, the components may be integrated into a single chip. The chip may be silicon-based.

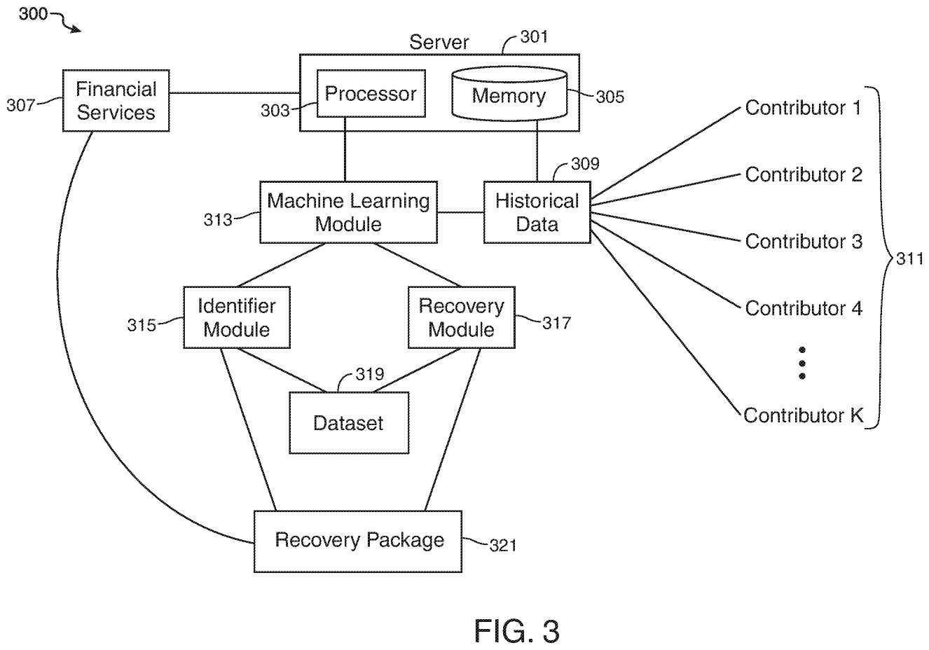

FIG. 3 shows illustrative system architecture 300 according to aspects of the disclosure. System architecture 300 may show one exemplary system architecture. Other embodiments may include different elements and/or arrangements than those shown in system architecture 300.

System architecture 300 includes server 301. Server 301 may include processor 303 and memory 305. Server 301 may be distributed. Server 301 may be cloud-based. Server 301 may be associated with financial services 307. The association may be direct—i.e., server 301 may directly provide some or all of financial services 307. The association may also be indirect—i.e., server 301 may trigger, or otherwise facilitate, financial services 307.

Server 301 may also be associated with historical data 309. Historical data 309 may be stored in memory 305. Historical data 309 may include information retrieved from contributors 1-k (311).

System architecture 300 may be associated with machine-learning (ML) module 313. ML module 313 may run on processor 303. ML module 313 may be stored in memory 305. ML module 313 may include ML models that are configured and trained to identify patterns of exploitations. ML module 313 may include ML models that are configured and trained to identify patterns (e.g., sequence of activity) that lead to successful recovery from exploitation. ML module 313 may be trained at least in part using historical data 309. ML module 313 may generate profiles of exploitations, profiles of recoveries, and/or a mapping that links each recovery profile to one or more exploitation profiles that have been recovered from via that recovery profile.

System architecture 300 may include identifier module 315 and/or recovery module 317. ML module 313, identifier module 315, and/or recovery module 317 may be applied to process dataset 319. Dataset 319 may be a set of activities of an individual. The individual may have opted-n to a program, e.g., an exploitation monitoring program. The activities in dataset 319 may include, inter alia, social media activity and/or financial activity of the individual.

Based at least in part on the processing of dataset 319, recovery module 317 may generate recovery package 321. Recovery package 321 may include one or more of financial services 307. Recovery package 321 may be generated, based at least in part on processing and analysis of ML module 313, identifier module 315, and/or recovery module 317, to historical data 309 and dataset 319, to mitigate a potential exploitation discovered in the dataset, and facilitate a successful recovery from the potential exploitation.

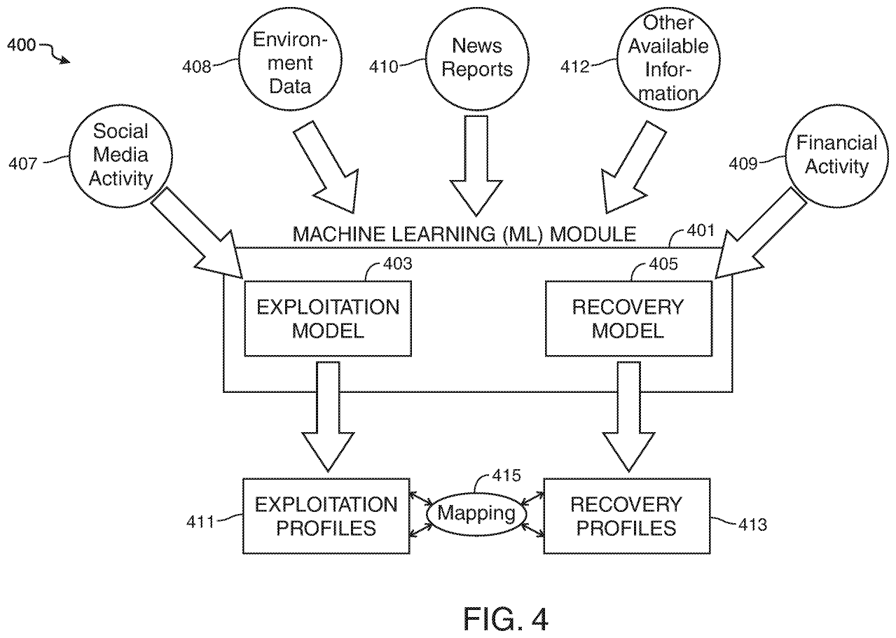

FIG. 4 shows illustrative system architecture 400 according to aspects of the disclosure. System architecture 400 may show one exemplary system architecture. Other embodiments may include different elements and/or arrangements than those shown in system architecture 400.

System architecture 400 includes ML module 401. ML module 401 may include multiple ML models. Each ML model may generate a score for a given set of input data. The score generated by each model may have a specific meaning. The meaning associated with each model may be tailored based on the data used to train that model. For example, one model may be exploitation model 403. Exploitation model 403 may be configured to process an input dataset and generate a score that may represent a probability of a potential exploitation. Another model may be recovery model 405. Recovery model 405 may be configured to process an input dataset and generate a score that may represent a probability of a recovery from an exploitation.

Some or all of the ML models included in ML module 401 may be trained at least in part based on historical data. Historical data may social media activity 407, environment data 408, financial activity 409, news reports 410, and/or other available information 412. In certain embodiments, some or all of the historical data may be artificial data engineered for training of ML models.

In some embodiments, certain types of historical data may be used to train specific ML models. For example, social media activity 407, environment data 408, financial activity 409, news reports 410, and/or other available information 412, may be used to train exploitation model 403, may be used to train recovery model 405. In these embodiments, a potential exploitation may be determined based on patterns of social media activity, and an appropriate recovery strategy may include financial services and resources.

ML module 401 may also be configured to generate exploitation profiles 411, recovery profiles 413, and a mapping 415. Exploitation profiles 411 may include patterns of activity indicative of a risk of exploitation. Recovery profiles 413 may include patterns of activity that resulted in recovery from an exploitation. Mapping 415 may link each recovery profile to the exploitation profile from which it recovered. The system may utilize exploitation profiles 411, recovery profiles 413, and mapping 415, at least in part, to determine an appropriate recovery package when a potential exploitation is discovered in a new dataset.

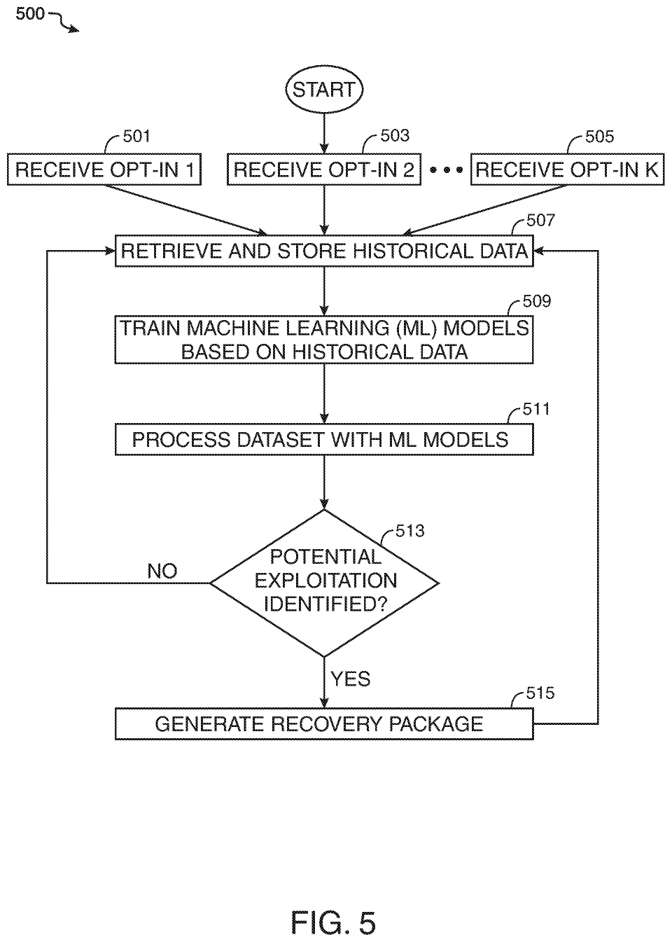

FIG. 5 shows exemplary flowchart 500 in accordance with aspects of the disclosure. Flowchart 500 shows one exemplary embodiment of a logical flow for providing machine-learning-based digital platforms with built-in financial exploitation protection. Other embodiments may include different steps and/or step sequences.

Flowchart 500 begins with receiving a set of opt-ins from contributors 1-K, at steps 501-505. Step 507 includes retrieving and storing historical data (which may include any of the data set forth in FIG. 4 derived from social media activity 407, environment data 408, financial activity 409, news reports 410, and other available data 412. Step 509 includes training machine-learning (ML) models based on the historical data. Step 511 includes processing a dataset in conjunction with the ML models. Step 513 queries whether a potential exploitation was identified based on the dataset. If a potential exploitation was not identified, the flowchart loops back to step 507, where new historical data may be retrieved, stored, and used for further training of the ML models (and if no new data is retrieved, the system may skip to step 511 and process a new dataset). If a potential exploitation was identified at step 513, the system may generate a recovery package at step 515, and loop back to 507, proceeding as above.

The steps of methods may be performed in an order other than the order shown and/or described herein. Embodiments may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown and/or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

The drawings show illustrative features of apparatus and methods in accordance with the principles of the invention. The features are illustrated in the context of selected embodiments. It will be understood that features shown in connection with one of the embodiments may be practiced in accordance with the principles of the invention along with features shown in connection with another of the embodiments.

One of ordinary skill in the art will appreciate that the steps shown and described herein may be performed in other than the recited order and that one or more steps illustrated may be optional. The methods of the above-referenced embodiments may involve the use of any suitable elements, steps, computer-executable instructions, or computer-readable data structures. In this regard, other embodiments are disclosed herein as well that can be partially or wholly implemented on a computer-readable medium, for example, by storing computer-executable instructions or modules or by utilizing computer-readable data structures.

Thus, methods and systems for machine-learning-based digital platforms with built-in financial exploitation protection are provided. Persons skilled in the art will appreciate that the present invention can be practiced by other than the described embodiments, which are presented for purposes of illustration rather than of limitation, and that the present invention is limited only by the claims that follow.

What is claimed is:

1. A machine-learning (ML)-based digital system for mitigating financial exploitation, said system comprising:
a central server, said central server comprising a processor and a memory;
a financial services module, said financial services module configured to provide, via the central server, a set of financial services;
a database, stored in the memory, comprising historical data, said historical data comprising information on the activities of a plurality of contributors, wherein the processor is configured to retrieve said information in response to said contributors opting-in to contribute to the historical data;
an ML module, said ML module comprising a set of ML models, said set of ML models that are trained at least in part based on historical data in the database;
an identifier module, said identifier module configured to process a dataset, and identify, in conjunction with the ML module, a potential exploitation, said identifier configured to implement sentiment analysis in identifying the potential exploitation, said implementing sentiment analysis comprising computationally identifying and categorizing opinions to determine whether a stated attitude of a contributor from among the plurality of contributors is positive, negative or neutral; and
a recovery module, said recovery module configured to generate, in conjunction with the ML module, a recovery package, said recovery package comprising one or more financial services from the set of financial services provided by the financial services module, wherein said recovery package is configured to mitigate the potential exploitation.

2. The system of claim 1, wherein the set of ML models comprises an exploitation model, said exploitation model that is configured to classify a pattern of activity and determine an association with an exploitation.

3. The system of claim 1, wherein the set of ML models comprises a recovery model, said recovery model that is configured to classify a pattern of activity and determine an association with a recovery from an exploitation.

4. The system of claim 1, further comprising:
an exploitation model that is part of the set of ML models, said exploitation model that is configured to classify a pattern of activity and determine an association with an exploitation;
a recovery model that is part of the set of ML models, said recovery model that is configured to classify a pattern of activity and determine an association with a recovery from an exploitation;
a set of exploitation profiles stored in the database, each of the exploitation profiles comprising a pattern of activity that is associated, by the exploitation model, with an exploitation;
a set of recovery profiles stored in the database, each of the recovery profiles comprising a pattern of activity that is associated, by the recovery model, with a recovery from an exploitation, each of said recovery profiles determined using sentiment analysis in forming the pattern of activity associated with the recovery from an exploitation; and
a mapping that links each of the recovery profiles to one or more exploitation profiles, said link representing a successful recovery, via the linked recovery profile, from the exploitation associated with the linked exploitation profile;
wherein the recovery module generates the recovery package based on the set of exploitation profiles, the set of recovery profiles, and the mapping.

5. The system of claim 4, further comprising a connection module, said connection module configured to create a digital communication link between an individual associated with the potential exploitation and one or more individuals associated with recovery profiles.

6. The system of claim 4, wherein the historical data comprises social media activity and financial activity, and wherein the exploitation profiles are based on the social media activity, and the recovery profiles are based on the financial activity.

7. The system of claim 4, further comprising a filtering module, said filtering module configured to retrieve contextual data, and leverage the contextual data to improve accuracy of the exploitation model and to reduce false positives in determining the exploitation profiles.

8. The system of claim 1, wherein the recovery package is implemented automatically.

9. The system of claim 1, wherein the dataset comprises data about social media activity and/or financial activity of an individual who opted-in to share said data.

10. A machine-learning (ML)-based method for mitigating financial exploitation, said method comprising:
receiving, at a processor, a plurality of opt-ins, each opt-in transmitted from one of a plurality of contributors;
retrieving historical data, said historical data comprising information on the activities of the contributors;
storing said historical data as a database in a memory;
training, based on the historical data, a machine-learning (ML) module, said ML module comprising a set of ML models;
processing, via the processor and in conjunction with the ML module, a dataset, to identify a potential exploitation, said identifying configured to implement sentiment analysis in identifying the potential exploitation; and
generating, in conjunction with the ML module, a recovery package, said recovery package comprising one or more financial services from a set of financial services provided via the processor, wherein said recovery package is configured to mitigate the potential exploitation.

11. The method of claim 10, wherein the set of ML models comprises an exploitation model and a recovery model, said exploitation model that is configured to classify a pattern of activity and determine an association with an exploitation, and said recovery model that is configured to classify a pattern of activity and determine an association with a recovery from an exploitation, and the method further comprises:
compiling a set of exploitation profiles, each of the exploitation profiles comprising a pattern of activity that is associated, by the exploitation model, with an exploitation;
compiling a set of recovery profiles, each of the recovery profiles comprising a pattern of activity that is associated, by the recovery model, with a recovery from an exploitation; and
creating a mapping that links each of the recovery profiles to one or more exploitation profiles, said link representing a successful recovery, via the linked recovery profile, from the exploitation associated with the linked exploitation profile;
wherein the generating the recovery package is based on the set of exploitation profiles, the set of recovery profiles, and the mapping.

12. The method of claim 11, further comprising creating a digital communication link between an individual associated with the potential exploitation and one or more individuals associated with recovery profiles.

13. The method of claim 11, wherein the historical data comprises social media activity and financial activity, and wherein the method further comprises basing the exploitation profiles on the social media activity, and basing the recovery profiles on the financial activity.

14. The method of claim 11, further comprising retrieving contextual data, and leveraging the contextual data to improve accuracy of the exploitation model and to reduce false positives in determining the exploitation profiles.

15. The method of claim 10, further comprising implementing the recovery package automatically.

16. The method of claim 10, further comprising:
retrieving, via the processor, data about social media activity and/or financial activity of an individual, said individual who opted-in to share said data; and
compiling said data into the dataset.

17. A digital financial platform with built-in exploitation protection, said platform configured to provide, via a processor, a set of financial services, said platform comprising:
a database, stored in a memory, comprising historical data, said historical data comprising information on the activities of a plurality of contributors, wherein the processor is configured to retrieve said information in response to said contributors opting-in to contribute to the historical data;
an ML module, said ML module comprising a set of ML models, said set of ML models that are trained based on the historical data in the database;
an identifier module, said identifier module configured to process a dataset, and identify, in conjunction with the ML module, a potential exploitation, said identifying configured to implement sentiment analysis in identifying the potential exploitation; and
a recovery module, said recovery module configured to generate, in conjunction with the ML module, a recovery package, said recovery package comprising one or more financial services from the set of financial services provided by the platform, wherein said recovery package is configured to mitigate the potential exploitation.

18. The platform of claim 17, further comprising:
an exploitation model that is part of the set of ML models, said exploitation model that is configured to classify a pattern of activity and determine an association with an exploitation;
a recovery model that is part of the set of ML models, said recovery model that is configured to classify a pattern of activity and determine an association with a recovery from an exploitation;
a set of exploitation profiles stored in the database, each of the exploitation profiles comprising a pattern of activity that is associated, by the exploitation model, with an exploitation;
a set of recovery profiles stored in the database, each of the recovery profiles comprising a pattern of activity that is associated, by the recovery model, with a recovery from an exploitation; and
a mapping that links each of the recovery profiles to one or more exploitation profiles, said link representing a successful recovery, via the linked recovery profile, from the exploitation associated with the linked exploitation profile;
wherein the recovery module generates the recovery package based on the set of exploitation profiles, the set of recovery profiles, and the mapping.

19. The platform of claim 18, further comprising:
a connection module, said connection module configured to create a digital communication link between an individual associated with the potential exploitation and one or more individuals associated with recovery profiles; and
a filtering module, said filtering module configured to retrieve contextual data, and leverage the contextual data to improve accuracy of the exploitation model and to reduce false positives in determining the exploitation profiles.

20. The platform of claim 18, wherein:
the historical data comprises social media activity and financial activity, and wherein the exploitation profiles are based on the social media activity, and the recovery profiles are based on the financial activity; and
the dataset comprises data about social media activity and/or financial activity of an individual who opted-in to share said data.
